(19) United States
(12) Patent Application Publication
(10) Pub. No.: US 2025/0039323 A1
(43) Pub. Date: Jan. 30, 2025

(54) STORAGE MEDIUM, METHOD OF CONTROLLING IMAGE PROCESSING APPARATUS, AND IMAGE PROCESSING APPARATUS

(71) Applicant: CANON KABUSHIKI KAISHA, Tokyo (JP)

(72) Inventor: YOHEI OKATANI, Kanagawa (JP)

(21) Appl. No.: 18/778,944

(22) Filed: Jul. 20, 2024

(30) Foreign Application Priority Data
Jul. 27, 2023 (JP) 2023-122391

(51) Int. Cl. H04N 1/44; H04N 1/00

(52) U.S. Cl. CPC H04N 1/4493; H04N 1/00206; H04N 1/00251; H04N 1/00392; H04N 1/00411

(57) ABSTRACT

A non-transitory computer readable storage medium storing an application which causes a computer to execute a method of controlling an image processing apparatus, the method including: displaying, on a display unit, a screen to designate a region where masking processing is performed using a method selected from a plurality of different methods, in which the region where the masking processing is performed in image data obtained by scanning a document by a scanner is designated; and performing the masking processing on the image data based on designation on the screen, wherein the plurality of different methods include a first method in which the region where the masking processing is performed is designated by selecting a type of a character string, and a second method in which the region where which the masking processing is performed is designated by designating a position of the region where the masking processing is performed.

### BACKGROUND OF THE INVENTION

### Field of the Invention

The present disclosure relates to a technique of masking an image.

### Description of the Related Art

In a case of sharing a document such as an identity verification document, an application document, or a drawing with another person, a part of the contents of the document is painted out and masked (hereinafter, also referred to as “to black out” or “to mask”) in some cases in order to protect private information, confidential information, and the like. For example, Japanese Patent Laid-Open No. 2021-033790 discloses a technique of masking a region in an image that corresponds to a region registered in advance.

### SUMMARY OF THE INVENTION

The present disclosure provides a non-transitory computer readable storage medium storing an application which causes a computer to execute a method of controlling an image processing apparatus, the method including: displaying, on a display unit, a screen to designate a region where masking processing is performed using a method selected from a plurality of different methods, in which the region where the masking processing is performed in image data obtained by scanning a document by a scanner included in the image processing apparatus is designated; and performing the masking processing on the image data based on designation on the screen, wherein the plurality of different methods include a first method in which the region where the masking processing is performed is designated by selecting a type of a character string included in the region where the masking processing is performed, and a second method in which the region where which the masking processing is performed is designated by designating a position of the region where the masking processing is performed.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of an information processing system;

FIG. 2 is a diagram illustrating a hardware configuration example of an information processing apparatus included in the present system;

FIG. 3 is a diagram illustrating a hardware configuration example of the information processing apparatus included in the present system;

FIG. 4 is a diagram illustrating a software configuration example of the information processing apparatus included in the present system;

FIG. 5 is a flowchart explaining overall processing executed by the present system;

FIGS. 6A and 6B are flowcharts explaining function designation processing executed by the present system;

FIGS. 7A to 7I are diagrams illustrating a screen configuration example of the present system;

FIG. 8 is a flowchart explaining masking region specifying processing;

FIG. 9 is a flowchart explaining masking editing processing;

FIGS. 10A and 10B are diagrams illustrating a screen configuration example of the present system;

FIG. 11 is a flowchart explaining preset registration processing; and

FIGS. 12A, 12B, and 12C are diagrams illustrating a screen configuration example of the present system.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

### First Embodiment

### <Overall Configuration>

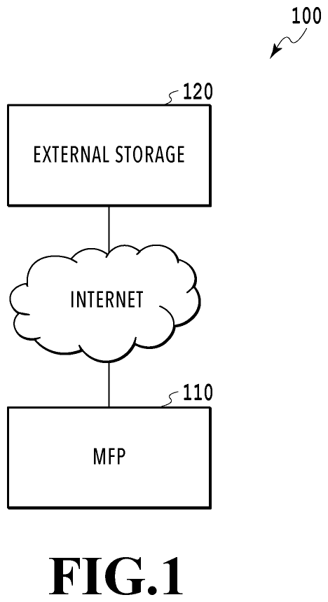

FIG. 1 is a diagram illustrating an overall configuration of an information processing system in the present embodiment. An information processing system 100 in FIG. 1 includes a multifunction peripheral (MFP) 110 and an external storage 120. The MFP 110 is communicably connected to a server providing various services on the Internet by way of a local area network (LAN).

The MFP 110 is a multifunction peripheral having plural functions of a scanner, a printer, and so on and is an example of an information processing apparatus or an image processing apparatus in the present disclosure. The MFP 110 has a function to transfer a scanned image file to a service that can save a file such as an external storage service. Note that, the information processing apparatus according to the present disclosure is not limited to the multifunction peripheral including a scanner and a printer and may be a personal computer (PC), a tablet terminal, a smartphone, or the like.

The external storage (service) 120 is a service that can save a file received via the Internet and obtain a file from an external apparatus through a web browser. The external storage 120 is a cloud service, for example. The external storage is not only limited to the external storage 120, and there may be plural external storages.

The information processing system according to the present embodiment has a configuration including the MFP 110 and the external storage 120; however, it is not limited thereto. For example, a part of a function and processing of the MFP 110 may be implemented by another server arranged on the Internet or on the LAN. Additionally, the external storage 120 may be arranged on the LAN instead of the Internet. In addition, the external storage 120 may be replaced with a mail server or the like and may transmit a scanned image attached to an e-mail. The MFP 110 may also have the saving function of the external storage 120.

### <Hardware Configuration of MFP 110>

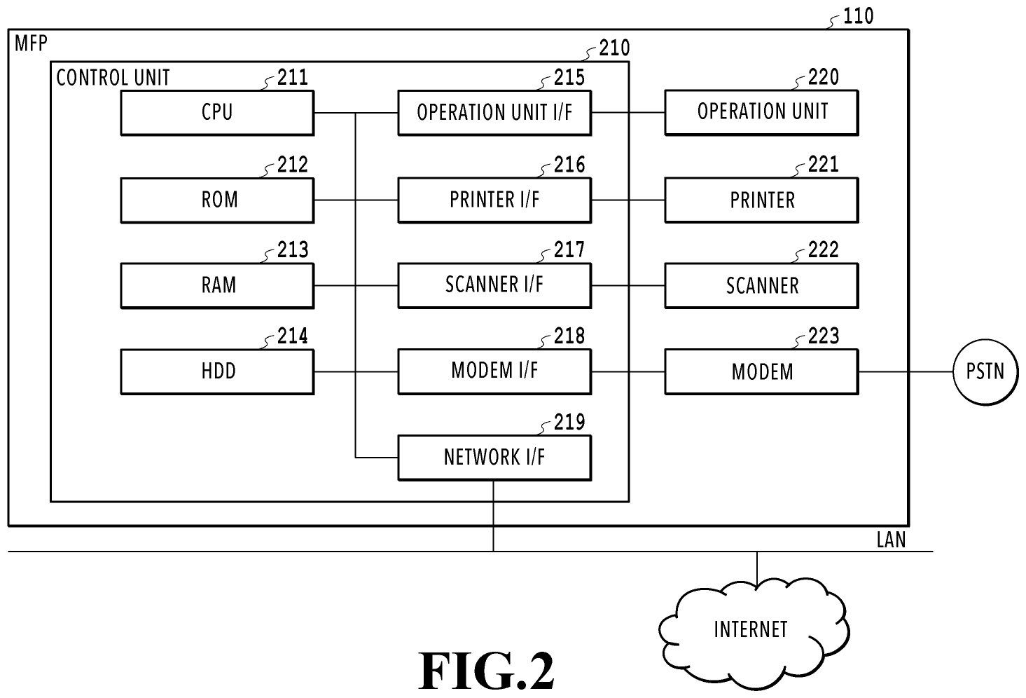

FIG. 2 is a hardware configuration diagram of the MFP 110. The MFP 110 includes a control unit 210, an operation unit 220, a printer 221, a scanner 222, and a modem 223. The control unit 210 includes units 211 to 219 described below and controls an operation of the overall MFP 110. A CPU 211 executes and controls various functions such as reading, printing, and communicating by deploying and reading out a control program stored in a ROM 212 and an HDD 214 to a RAM 213. The RAM 213 is used as a temporary storage region such as a main memory and a working area of the CPU 211. Note that, in the present embodiment, each processing illustrated in the later-described flowchart is executed with the single CPU 211 using a single memory (the RAM 213 or the HDD 214); however, it is not limited thereto. For example, plural CPUs may execute each processing in cooperation with plural RAMs or HDDs. The HDD 214 is a high-capacity storage unit that stores document image data or image data and various programs. In the subsequent explanations, although a term “image” is used for the descriptions, “image” also includes “document image”. Accordingly, masking of the contents of an image also includes masking of the contents of a document image.

An operation unit I/F 215 is an interface that connects the operation unit 220 and the control unit 210 with each other. The operation unit 220 includes a touch panel, a keyboard, and so on and receives an operation, an input, or an instruction from the user. A printer I/F 216 is an interface that connects the printer 221 and the control unit 210 with each other. The image data for printing is transferred from the control unit 210 to the printer 221 via the printer I/F 216 and printed on a printing medium. A scanner I/F 217 is an interface that connects the scanner 222 and the control unit 210 with each other. The scanner 222 generates the image data by reading an original document set on a document table (not illustrated) or an auto document feeder (ADF) (not illustrated) and inputs the image data to the control unit 210 via the scanner I/F 217. The MFP 110 performs not only causes the printer 221 to print and output (copy) the image data generated by the scanner 222 but also performs file transmission or e-mail transmission. A modem I/F 218 is an interface that connects the modem 223 and the control unit 210 with each other. The modem 223 establishes facsimile communication of the image data between the MFP 110 and a facsimile device on a PSTN. A network I/F 219 is an interface that connects the control unit 210 (the MFP 110) to the LAN. The MFP 110 uses the network I/F 219 to transmit the image data and information to each service on the Internet and receive various types of information.

### <Hardware Configuration of External Storage 120>

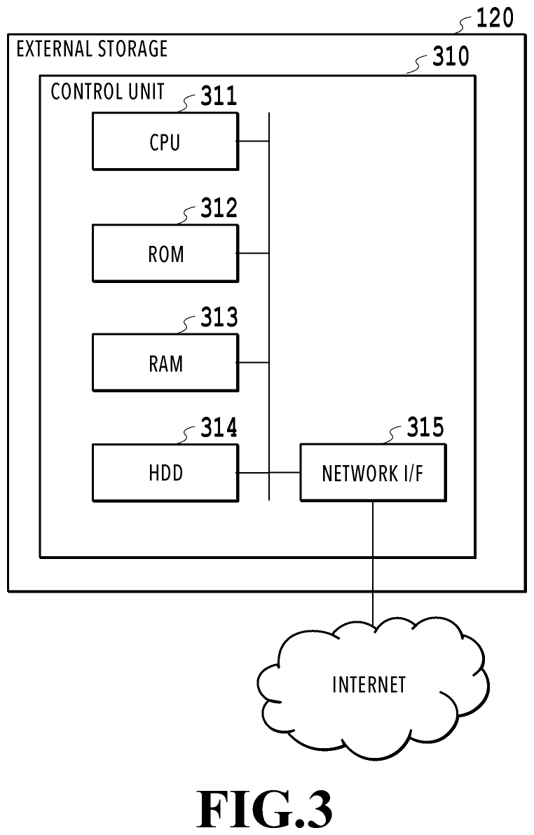

FIG. 3 is a hardware configuration diagram of the external storage 120. The external storage 120 includes a CPU 311, a ROM 312, a RAM 313, an HDD 314 and a network I/F 315. The CPU 311 controls overall operations of the external storage 120 by deploying a control program stored in the ROM 312 to the RAM 313 and executing various types of processing. The RAM 313 is used as a temporary storage region such as a main memory and a working area of the CPU 311. The HDD 314 a high-capacity storage unit that stores the image data and various programs. The network I/F 315 is an interface that connects the external storage 120 to the Internet. The external storage 120 transmits and receives various types of information in response to a processing request from another device such as the MFP 110 via the network I/F 315.

### <Software Configuration of MFP 110>

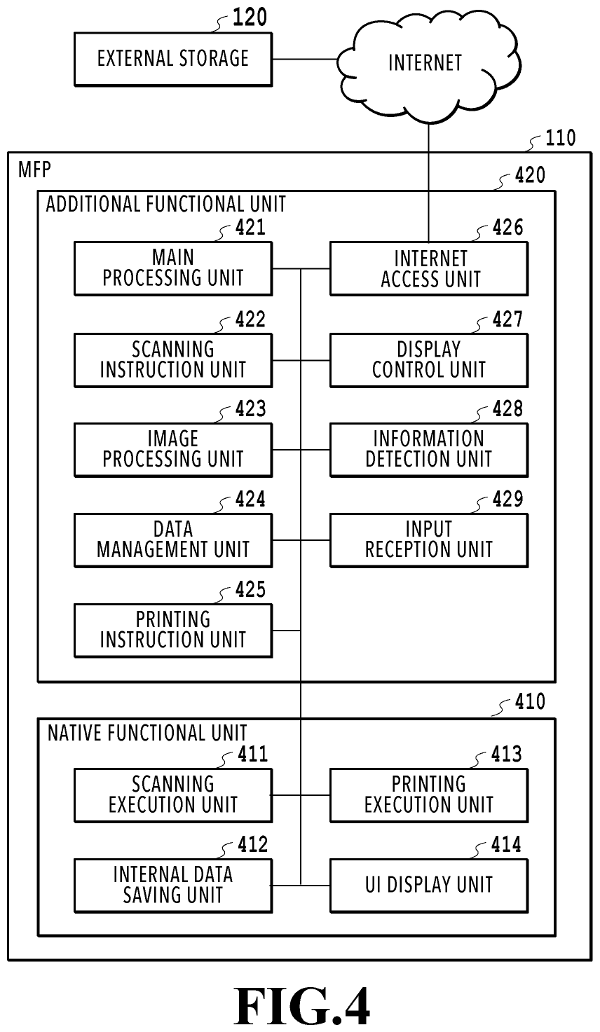

FIG. 4 is a software configuration diagram of the MFP 110 according to the present embodiment. The software configuration of the MFP 110 includes a native functional unit 410 and an additional functional unit 420. Each functional unit is implemented with the CPU 211 deploying the program stored in the ROM 212 and the HDD 214 of the MFP 110 to the RAM 213 and executing the program. Each unit included in the native functional unit 410 is a function provided as standard in the MFP 110. The additional functional unit 420 is an application additionally installed in the MFP 110. The additional functional unit 420 is an application based on Java (registered trademark), and the adding of the function to the MFP 110 is implemented easily. Note that, another not-illustrated additional application may be installed in the MFP 110.

The native functional unit 410 includes a scanning execution unit 411, an internal data saving unit 412, a printing execution unit 413, and a user interface (UI) display unit 414. The additional functional unit 420 includes a main processing unit 421, a scanning instruction unit 422, an image processing unit 423, a data management unit 424, a printing instruction unit 425, an Internet access unit 426, a display control unit 427, an information detection unit 428, and an input reception unit 429.

The scanning execution unit 411 receives a scanning request including scanning setting from the scanning instruction unit 422 described later. According to the scanning request, the scanning execution unit 411 reads the original document put on the document table (not illustrated) by the scanner 222 via the scanner I/F 217 and thus generates scanned image data. The internal data saving unit 412 saves information requested by the later-described data management unit 424 to the HDD 214 or obtains information requested by the data management unit 424 from the HDD 214. The printing execution unit 413 receives a printing request including printing setting and an image identifier from the printing instruction unit 425 described later. The printing execution unit 413 obtains data corresponding to the image identifier from the internal data saving unit 412 and generates the image data for printing according to the printing request. According to the generated image data for printing, the printing execution unit 413 prints a mask composite image on the printing medium by the printer 221 via the printer I/F 216. The UI display unit 414 displays a UI screen to receive an operation by the user on a liquid crystal display unit having a touch panel function of the operation unit 220 of the MFP 110. For example, an operation screen and the like to receive scanning setting, an operation to start scanning, a preview of a scanned image, an operation to designate a masking region described later, a preview of the mask composite image, output setting, and an operation to start outputting is displayed.

The main processing unit 421 has a function of general processing on the additional functional unit 420. Specifically, the main processing unit 421 controls overall processing of the additional functional unit 420 and requests the units included in the additional functional unit 420 to perform processing. The scanning instruction unit 422 requests the scanning execution unit 411 to perform scanning processing according to the scanning setting inputted via the UI screen. The image processing unit 423 performs analysis processing and image processing on the image data. The image processing unit 423 performs recognition processing on the image such as analysis of a character region in the image data, optical character recognition (OCR), and oblique correction and rotation correction of the image. Additionally, the image processing unit 423 generates a masking image in which a designated portion that is designated as the masking region on the image is masked. The masking region is information indicating coordinates of a starting point and an ending point of a rectangular region masked in the image. The coordinates are expressed by (x coordinate, y coordinate). For example, the masking region is information indicating the coordinates of the starting point and the ending point of the rectangular region like “(441,957), (1369,1057)”. In the present embodiment, the masking region is the rectangular region; however, the shape may be oval, triangle, or the like. The masking image is an image in which the above-mentioned masking region is masked on the image data. The masking may be painting out with black color, hiding by a background color, or masking by another method. Moreover, the image processing unit 423 determines whether an extracted character string matches a designated character string and determines whether to mask the extracted character string. Furthermore, the image processing unit 423 determines whether an information type detected by the information detection unit 428 matches a designated information type and determines whether to mask the character string corresponding to the information type. The masking processing in the present embodiment is processing to overlap an image on a partial region in the scanned image and hide the information in the partial region. The image may be rectangular or another shape. The image may be an image painted out with black, an image painted out with white, or an image painted out with another color. Additionally, the image is not limited to a single-color image and may be an image with patterns. Moreover, processing to delete a pixel included in the partial region in the scanned image may be performed without overlapping the image. For example, in a case of a monochrome image, processing to delete a black pixel included in the partial region may be performed. Furthermore, in a PDF file and the like, text data in the image obtained as a result of the OCR processing on the image may be held in the file. In the masking processing, the masking image in which the image is overlapped with the partial region in the scanned image may be generated, and in addition, the text data included in the partial region may be deleted. The masking processing is also called “black out” or “reduction”.

The data management unit 424 saves and obtains the image data and a preset. The data management unit 424 may save and obtain other necessary information. The preset is information saved so as to be able to reuse the designation by the user in the masking, and use of the preset makes it possible to execute the masking without making individual setting again. The preset includes a preset name, a size of the image, the masking region, a masking character string, and a masking type. Additionally, the preset may include other information.

The masking region is the coordinates of the rectangular region on the image as a masking target. The masking character string is a character string as the masking target. The masking type is a type of the masking target. For example, the masking type includes the information type that is detectable by the information detection unit 428 described later. Additionally, for example, the masking type includes a type indicating that it is region information such as “rectangular region”. Moreover, for example, the masking type includes a type indicating that it is the character string designated by the user such as “designated character string”. Furthermore, the masking type may include another type.

The data management unit 424 requests the internal data saving unit 412 to save the information to the inside of the MFP 110 or to obtain the information from the inside of the MFP 110. Additionally, the data management unit 424 may request the Internet access unit 426 to save the information to the external storage 120 or to obtain the information from the external storage 120. The printing instruction unit 425 transmits the request of printing processing according to the printing setting inputted via the UI screen and the image identifier received from the image processing unit 423 to the printing execution unit 413.

The Internet access unit 426 transmits the processing request to a cloud service and the like providing a storage function (a storage service). In general, the cloud service uses a protocol such as REST and SOAP to save a file to the cloud storage. The cloud service also discloses various interfaces for obtaining a saved file from an external apparatus. The Internet access unit 426 operates the cloud service by using the disclosed interface of the cloud service. The Internet access unit 426 obtains from the data management unit 424 a file and transmission information corresponding to the image identifier received from the image processing unit 423. The Internet access unit 426 uses the transmission information obtained from the data management unit 424 to transmit the file obtained from the data management unit 424 to the external storage 120 via the network I/F 315.

The display control unit 427 controls displaying of the UI screen to receive the operation by the user on the liquid crystal display unit having the touch panel function of the operation unit 220 of the MFP 110. The information detection unit 428 determines whether the character string corresponds to a predetermined detectable information type and generates an information detection result storing the character string, the character string region, and the corresponding information type. The detectable information type is a type of a concept expressed by the character string and is used to designate the character string as the masking target. In the present embodiment, the detectable information type indicates a type of private information or confidential information such as “name”, “credit card number”, and “e-mail address”; however, it is not limited thereto. The information detection unit 428 also determines whether the character string corresponds to the predetermined detectable information type. For example, the information detection unit 428 determines that the character string “Taro Yamada” corresponds to the information type “name”. The information detection unit 428 determines that the character string that does not correspond to any information type is the information type “-(NA)”. Additionally, in the present embodiment, the information detection unit 428 holds a list of the predetermined detectable information types. The place for holding is not limited to the information detection unit 428 and may be the external storage 120 and the like, for example. The input reception unit 429 receives a user input on the UI screen displayed by the display control unit 427.

### <Overall Processing Flow>

Processing to execute and control the various functions of the MFP 110 and a function of an additional application is implemented by the CPU 211 of the MFP 110 deploying the control program stored in the ROM 212 and the HDD 214 to the RAM 213 and executing the control program.

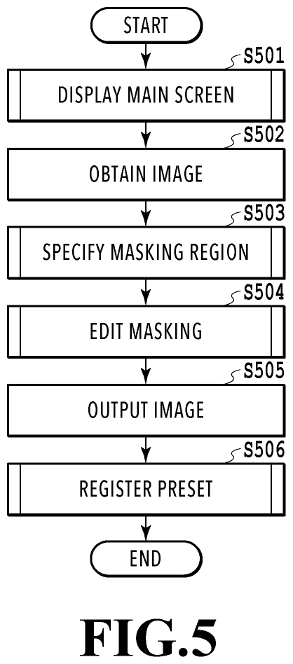

FIG. 5 is a flowchart of generating the masking image from the image scanned by the MFP 110 and printing the masking image. In addition to printing, the masking image may be converted into a file and transmitted to the cloud storage (the external storage 120). Note that, although an example in which the display control unit 427 displays a screen on the touch panel of the operation unit 220 is described in the present embodiment, a configuration in which the display control unit 427 provides each screen in the present embodiment to another apparatus to allow an operation unit of the other apparatus to display the screen may be applied.

In the present disclosure, the additional application (hereinafter, referred to as a “masking app”) that masks the partial region of the scanned image and transmits the image to the cloud service becomes available by being installed in the MFP 110. In a case where the masking app is installed in the MFP 110, a button to use the function of the application is displayed on a main screen of the MFP 110.

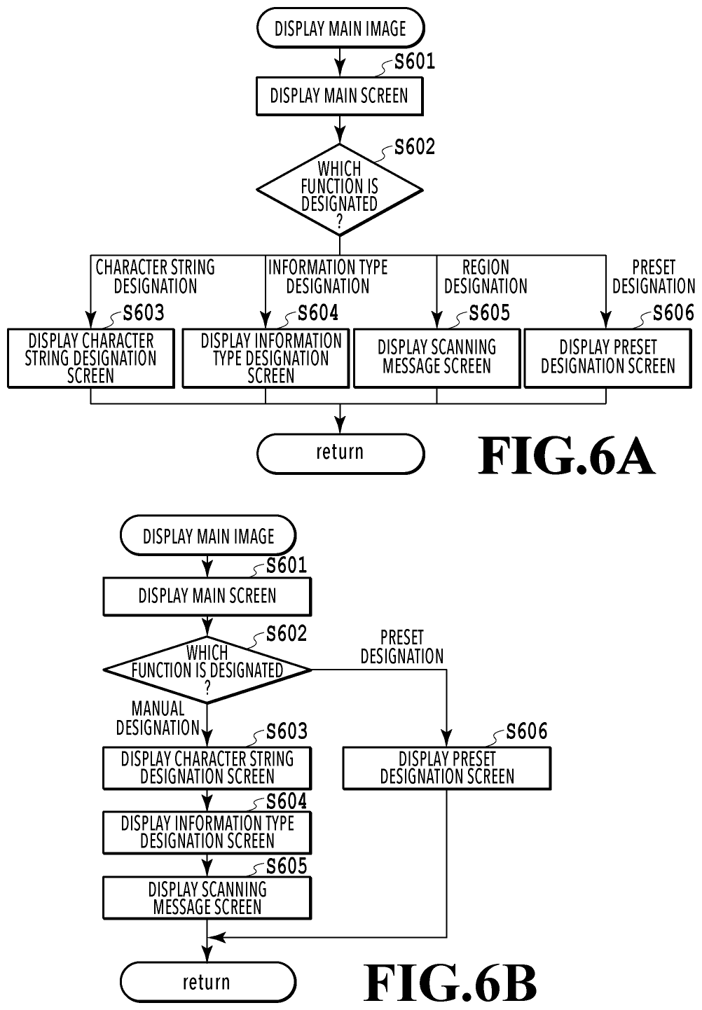

In S501, the CPU 211 displays on the touch panel of the operation unit 220 the main screen on which the button to execute the application provided by the MFP 110 is arranged via the display control unit 427. In addition, the CPU 211 creates job information based on the designation received from the user via the input reception unit 429. The job information includes a masking mode, the masking character string, the masking type, and the masking region that are designated by the user. Additionally, other information may be included in the job information. Details are described with reference to FIGS. 6A and 6B.

In S502, the CPU 211 requests scanning via the scanning instruction unit 422 and the scanning execution unit 411, obtains the scanned image data, and holds the image data in the RAM 213. In the present embodiment, the CPU 211 obtains the image data by scanning; however, the image data may be obtained from the HDD 214 via the data management unit 424 and the internal data saving unit 412. Additionally, the CPU 211 may obtain the image data from the external storage 120 via the data management unit 424 and the Internet access unit 426. The CPU 211 may obtain the image data by using another unit.

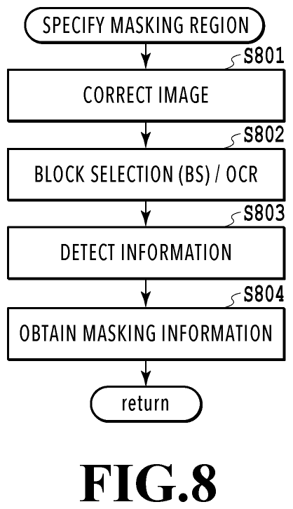

In S503, the CPU 211 generates masking information from the job information obtained in S501 and the image data obtained in S502 via the image processing unit 423. the CPU 211 performs oblique correction and rotation correction on the image data obtained in S502 and generates corrected image data via the image processing unit 423. In addition, the CPU 211 analyzes the corrected image data via the image processing unit 423 and compares the corrected image data with the job information obtained in S501 to generate the masking information. Details are described with reference to FIG. 8.

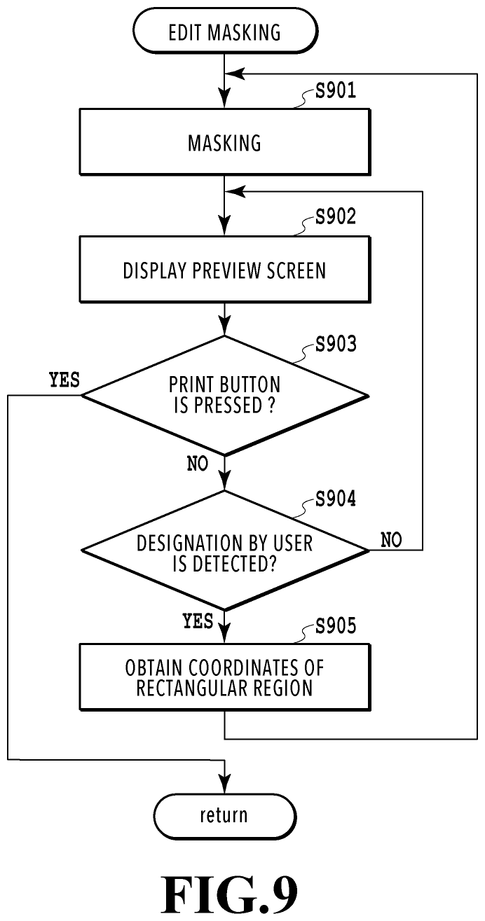

In S504, the CPU 211 creates the masking image based on the corrected image data and the masking information generated in S503 via the image processing unit 423. Subsequently, the CPU 211 generates and displays a preview screen on which the masking image created can be viewed and revised as needed via the main processing unit 421 and the display control unit 427. The CPU 211 generates the preview screen, displays the preview screen on the touch panel of the operation unit 220 via the display control unit 427, and revises the masking image based on the designation received from the user. Details are described later with reference to FIG. 9.

In S505, the CPU 211 prints the masking image created in S504 via the main processing unit 421, the printing instruction unit 425, and the printing execution unit 413. In the present embodiment, the CPU 211 generates a printed product of the masking image by printing via the main processing unit 421; however, it is not limited thereto. The CPU 211 may save the image to the HDD 214 via the data management unit 424 and the internal data saving unit 412. Additionally, the CPU 211 may save the image to the external storage 120 and transmit an e-mail to any destination via the data management unit 424 and the Internet access unit 426. The CPU 211 may save the image by using another unit.

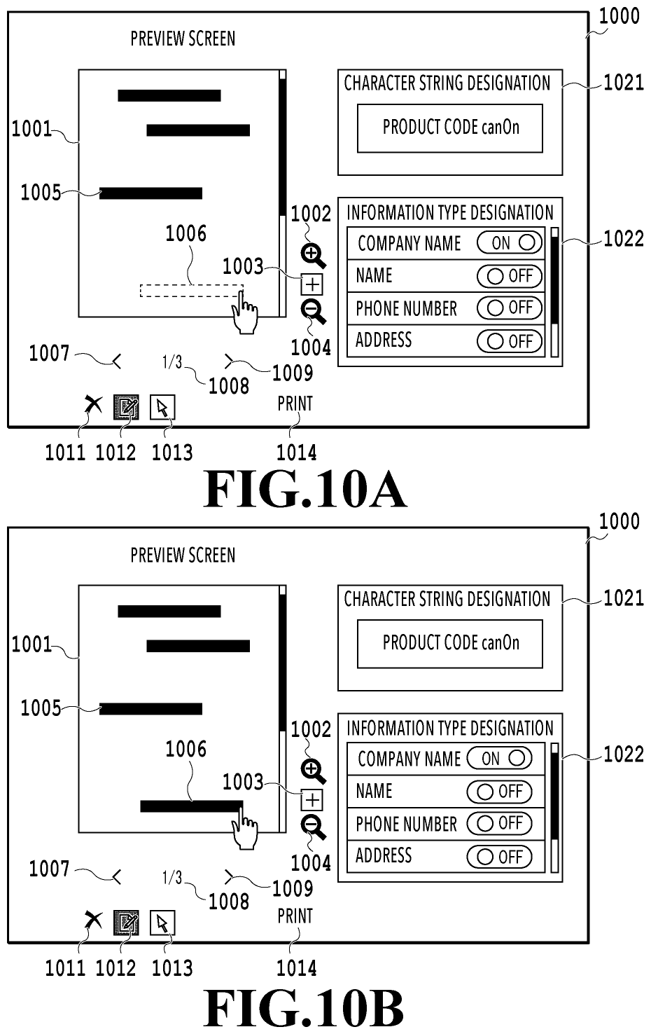

In S506, the CPU 211 generates a preset registration screen via the display control unit 427, displays the preset registration screen on the touch panel of the operation unit 220, and registers the preset based on the designation received from the user. Details are described later with reference to FIGS. 10A and 10B.

### <Function Selection Flow>

FIG. 6A is a flowchart explaining the main screen displaying processing in S501 in the present embodiment. In S601, the CPU 211 generates the main screen to receive the designation of the masking mode executed in the present embodiment via the display control unit 427 and displays the main screen on the touch panel of the operation unit 220 via the UI display unit 414. In this case, the masking mode is a type of the masking processing executed in the present embodiment. The masking mode includes character string designation (character string masking processing), information type designation (information type masking processing), region designation (region masking processing), and preset designation (preset masking processing).

The character string designation is a mode to mask the character string corresponding to the designated character string. The information type designation is a mode to mask the character string corresponding to the designated information type. The region designation is a mode to mask the rectangular region designated on the preview screen. The preset designation is a mode to designate the masking information in a case of performing the character string designation, the information type designation, or the region designation that is saved in advance as the preset and to perform masking according to the contents of the preset.

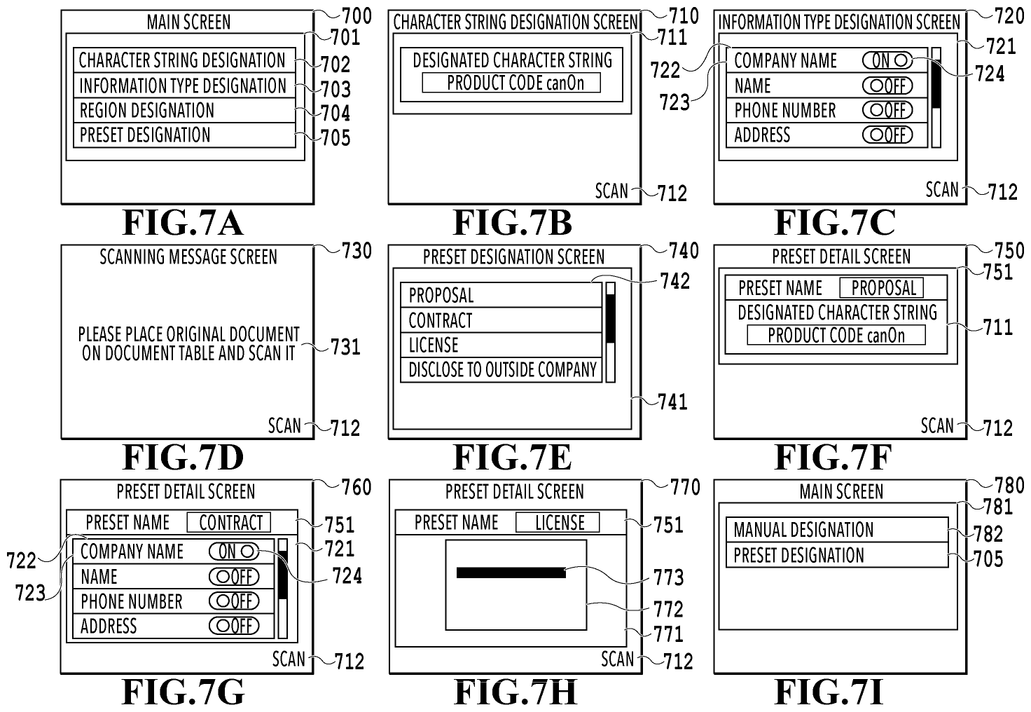

FIG. 7A illustrates an example of the main screen in the present embodiment. A main screen 700 includes a masking mode list 701. In the present embodiment, the masking mode list 701 includes a character string designation button 702, an information type designation button 703, a region designation button 704, and a preset designation button 705; however, the masking mode list 701 may include another button.

In a case where the CPU 211 detects that the user presses the character string designation button 702 via the input reception unit 429, the CPU 211 sets the masking mode to the “character string designation” and allows the screen to transition to a character string designation screen 710 illustrated in FIG. 7B. In a case where the masking mode is the character string designation, the character string region of the corresponding character string is automatically masked in a flowchart of FIG. 8 described later.

In a case where the CPU 211 detects that the user presses the information type designation button 703 via the input reception unit 429, the CPU 211 sets the masking mode to the “information type designation” and allows the screen to transition to an information type designation screen 720 illustrated in FIG. 7C. In a case where the masking mode is the information type designation, information is detected according to the flowchart of FIG. 8 described later, and the character string region corresponding to the concerned information type is automatically masked.

In a case where the CPU 211 detects that the user presses the region designation button 704 via the input reception unit 429, the CPU 211 sets the masking mode to the “region designation” and allows the screen to transition to a scanning message screen 730 illustrated in FIG. 7D. In a case where the masking mode is the region designation, the coordinates of the rectangular region are obtained according to the flowchart of FIG. 8 described later, and the rectangular region designated in response to the pressing by the user is masked. Accordingly, the “region designation” is the masking processing that can be used regardless of whether the later-described character recognition processing is executed.

In a case where the CPU 211 detects that the user presses the preset designation button 705 via the input reception unit 429, the CPU 211 sets the masking mode to the “preset designation” and allows the screen to transition to a preset designation screen 740 illustrated in FIG. 7E. In a case where the masking mode is the preset designation, the masking region is determined according to the contents of the designated preset in the flowchart of FIG. 8 described later. The determined masking region is masked.

In response to the pressing of any button included in the masking mode list 701 by the user, the main screen 700 sets the masking mode and allows the screen to transition to a screen corresponding to the masking mode. In a case where the main screen 700 is displayed, the processing proceeds to S602.

In S602, the CPU 211 determines the masking mode set in S601 via the display control unit 427 and the input reception unit 429. In a case where the masking mode is the character string designation (S602 is the character string designation), the processing proceeds to S603. In a case where the masking mode is the information type designation (S602 is the information type designation), the processing proceeds to S604. In a case where the masking mode is the region designation (S602 is the region designation), the processing proceeds to S605. In a case where the masking mode is the preset designation (S602 is the preset designation), the processing proceeds to S606.

In S603, the CPU 211 generates the character string designation screen 710 via the display control unit 427 and displays the character string designation screen 710 on the touch panel of the operation unit 220 via the UI display unit 414. The character string designation screen 710 is a screen to receive the character string as the masking target. In a case where a scan button 712 is pressed on the character string designation screen 710, the CPU 211 generates the job information, and the processing of the flowchart illustrated in FIG. 6A ends.

FIG. 7B illustrates an example of the character string designation screen 710 in the present embodiment. The character string designation screen 710 includes a character string input form 711 and the scan button 712. Additionally, the character string designation screen 710 may include another form, button, or the like. The character string input form 711 is a form to input the character string as the masking target. For example, in a case of masking a character string “product code can0n”, the CPU 211 receives an input of the character string by the user to the character string input form 711 via the input reception unit 429. In a case where the scan button 712 is pressed on the character string designation screen 710, the CPU 211 generates the job information via the display control unit 427 and adds the masking mode set in S601 to the job information. In addition, the CPU 211 adds the character string inputted to the character string input form 711 via the display control unit 427 and the input reception unit 429 to the job information. For example, in a case where “product code can0n” is inputted to the character string input form 711, the CPU 211 adds “product code can0n” as the masking character string and “designated character string” as the masking type to the job information via the display control unit 427. Subsequently, the CPU 211 holds the job information in the RAM 213 via the display control unit 427 and ends the processing flow of the flowchart illustrated in FIG. 6A. Note that, a configuration in which the later-described information type designation screen is subsequently displayed before the processing flow of the flowchart illustrated in FIG. 6A ends may be applied.

In S604, the CPU 211 obtains the list of the predetermined detectable information types via the display control unit 427 and the information detection unit 428 and generates the information type designation screen 720. Subsequently, the CPU 211 displays the information type designation screen 720 on the touch panel of the operation unit 220 via the UI display unit 414. The information type designation screen 720 is a screen to receive the detectable information type as the masking target. In a case where the scan button 712 is pressed on the information type designation screen 720, the CPU 211 generates the job information, and the processing of the flowchart illustrated in FIG. 6A ends.

FIG. 7C illustrates an example of the information type designation screen 720 in the present embodiment. The information type designation screen 720 includes an information type list 721 and the scan button 712. Additionally, the information type designation screen 720 may include another button or the like. The information type list 721 is a region to list and display information type items 722 corresponding to the number of the detectable information types. For example, in a case where the detectable information types are “company name, name, phone number, address”, the information type items 722 of “company name, name, phone number, address” are displayed on the information type list 721. The detectable information type may include “FAX number, e-mail address, URL, credit card number, one dimensional or two dimensional code image” and the like. In a case where the information type items 722 are not all fitted within the display region, the information type list 721 may display a scroll bar to allow for scroll display.

Each information type item 722 includes an information type name 723 and a toggle button 724. The information type name 723 is a region to display an information type name. The toggle button 724 is a button to be set to ON in a case of designating the information type displayed in the information type name 723 as the masking target and to be set to OFF in a case of not designating the information type displayed in the information type name 723 as the masking target. For example, in a case where the information type “company name” is designated as the masking target, the CPU 211 receives the pressing by the user via the input reception unit 429, and the toggle button corresponding to the information type “company name” is set to ON.

In a case where the scan button 712 is pressed on the information type designation screen 720, the CPU 211 generates the job information via the display control unit 427 and adds the masking mode set in S601 to the job information. In addition, the CPU 211 adds all the information types having the toggle buttons 724 set to ON in the information type list 721 to the job information via the display control unit 427. For example, in a case where the toggle button of the information type “company name” is ON in the information type list 721, the CPU 211 adds the information type “company name” to the job information as the masking type via the display control unit 427. Subsequently, the CPU 211 holds the job information in the RAM 213 via the display control unit 427, and the processing flow of the flowchart illustrated in FIG. 6A ends. Note that, a configuration in which the character string designation screen is subsequently displayed before the processing flow of the flowchart illustrated in FIG. 6A ends may be applied. In a case where such a configuration is employed, it is possible to perform the masking processing that is a combination of the “information type designation” and the “character string designation”.

In S605, the CPU 211 generates the scanning message screen 730 via the display control unit 427 and displays the scanning message screen 730 on the touch panel of the operation unit 220 via the UI display unit 414. The scanning message screen is a screen to display a prompt to the user to perform scanning. In a case where the scan button 712 is pressed on the scanning message screen 730, the CPU 211 generates the job information, and the processing of the flowchart illustrated in FIG. 6A ends.

FIG. 7D illustrates an example of the scanning message screen 730 in the present embodiment. The scanning message screen 730 includes a message 731 and the scan button 712. Additionally, the scanning message screen 730 may include another button or the like. The message 731 is a region to display the prompt to the user to perform scanning. In a case where the scan button 712 is pressed on the scanning message screen 730, the CPU 211 generates the job information via the display control unit 427 and adds the masking mode set in S601 to the job information. In addition, the CPU 211 adds a blank masking type to the job information via the display control unit 427. Subsequently, the CPU 211 holds the job information in the RAM 213 via the display control unit 427, and the processing flow of the flowchart illustrated in FIG. 6A ends.

Thereafter, in a case where the user reads the original document by the MFP 110, the CPU 211 displays the read image on the touch panel via the display control unit 427 and the UI display unit 414. In a case where a PC or the like is used instead of the MFP 110, an image of the selected file is displayed on the touch panel. The user designates the masking region by a finger, a stylus pen, or the like, which is described later in detail.

In S606, the CPU 211 obtains an already-registered preset list via the display control unit 427 and the data management unit 424. Specifically, the CPU 211 obtains the preset list from the HDD 214 via the data management unit 424, the internal data saving unit 412, and the display control unit 427. Additionally, the CPU 211 may obtain the preset list from the external storage 120 via the data management unit 424 and the Internet access unit 426. The CPU 211 may obtain the preset list by using another unit. The CPU 211 takes out each preset name from the preset list obtained via the display control unit 427 to generate the preset designation screen 740 and displays the preset designation screen 740 on the touch panel of the operation unit 220 via the UI display unit 414. The preset designation screen 740 is a screen to display the preset list and receive designation of any preset. In a case where the scan button 712 is pressed on the preset designation screen 740, the CPU 211 generates the job information, and the processing of the flowchart illustrated in FIG. 6A ends.

FIG. 7E illustrates an example of the preset designation screen in the present embodiment. The preset designation screen 740 includes a preset list 741. The preset list 741 is a region to list and display preset buttons 742 corresponding to the number of the presets in the preset list. For example, in a case where the preset list is presets of “proposal, contract, license, disclose to outside company”, the preset buttons “proposal, contract, license, disclose to outside company” are displayed on the preset list 741. In a case where the preset buttons 742 are not all fitted within the display region, the preset list 741 may display a scroll bar to allow for scroll display. Each preset button 742 is a button to designate the preset. The CPU 211 receives pressing of any one of the preset buttons 742 displayed on the preset list 741 by the user via the display control unit 427 and the input reception unit 429. In a case where the pressing by the user is received, the CPU 211 generates a preset detail screen based on the contents of the corresponding preset via the display control unit 427 and displays the preset detail screen on the touch panel of the operation unit 220 via the UI display unit 414. The preset detail screen is a screen to display the masking setting of the designated preset. For example, in a case where the preset “contract” is designated, the preset detail screen that displays the masking setting of the preset “contract” is generated.

In a case where the contents of the preset are the masking character string, the CPU 211 generates the preset detail screen for the character string designation via the display control unit 427. In a case where the contents of the preset are the masking type, the CPU 211 generates the preset detail screen for the information type designation via the display control unit 427. In a case where the contents of the preset are the masking region, the CPU 211 generates the preset detail screen for the region designation via the display control unit 427. Additionally, in a case where the contents of the preset are composite contents including the masking character string, the masking type, and the masking region, the CPU 211 may display the preset detail screens so as to be switchable from each other via the display control unit 427.

FIG. 7F illustrates an example of the preset detail screen for the character string designation in the present embodiment. A preset detail screen 750 includes a preset name 751, the character string input form 711, and the scan button 712. The preset name 751 displays the name of the corresponding preset. The masking character string of the corresponding preset is inputted to the character string input form 711 by default. Additionally, in the character string input form 711, the masking character string may be edited freely by the user in response to the input.

In a case where the scan button 712 is pressed on the preset detail screen 750, the CPU 211 generates the job information via the display control unit 427 and adds the masking mode set in S601 to the job information. In addition, the CPU 211 adds the character string inputted to the character string input form 711 via the display control unit 427 and the input reception unit 429 to the job information as the masking character string. Subsequently, the CPU 211 holds the job information in the RAM 213 via the display control unit 427 and ends the processing flow of the flowchart illustrated in FIG. 6A.

FIG. 7G illustrates an example of the preset detail screen for the information type designation in the present embodiment. A preset detail screen 760 includes the preset name 751, the information type list 721, and the scan button 712. The toggle button of the information type item 722 included in the masking type of the preset in the information type list 721 is switched to ON by default. In a case where the information type item 722 is not included in the masking type of the preset, the toggle button is switched to OFF by default. Additionally, the toggle button may be edited freely in response to the pressing by the user.

In a case where the scan button 712 is pressed on the preset detail screen 760, the CPU 211 generates the job information via the display control unit 427 and adds the masking mode set in S601 to the job information. In addition, the CPU 211 adds all the information types having the toggle buttons 724 set to ON in the information type list 721 to the job information as the masking type via the display control unit 427. Subsequently, the CPU 211 holds the job information in the RAM 213 via the display control unit 427 and ends the processing flow of the flowchart illustrated in FIG. 6A.

FIG. 7H illustrates an example of the preset detail screen for the region designation in the present embodiment. A preset detail screen 770 includes the preset name 751, a preset preview 771, and the scan button 712. The preset preview 771 includes an image outline preview 772 and a masking 773. The image outline preview 772 displays an outline of the image by using the image size included in the preset. The masking 773 is displayed based on the masking region included in the preset by performing masking in the same positions of the coordinates on the image outline preview 772. In this case, the masking 773 is the designated masking region received by the CPU 211 via the input reception unit 429. The preset preview 771 displays a region in the image that is to be masked by displaying the image outline preview 772 and the masking 773.

In a case where the scan button 712 is pressed on the preset detail screen 770, the CPU 211 generates the job information via the display control unit 427 and adds the masking mode set in S601 to the job information. In addition, the CPU 211 adds the masking region of the corresponding preset to the job information via the display control unit 427. For example, in a case where the masking region of the preset is “(441,957), (1369, 1057)”, the CPU 211 sets the masking type as “rectangular region” and the masking region as “(441, 957), (1369, 1057)” and adds the masking type and the masking region to the job information. Subsequently, the CPU 211 holds the job information in the RAM 213 via the display control unit 427 and ends the processing flow of the flowchart illustrated in FIG. 6A.

In a case where the contents of the preset are composite, and the preset detail screens are displayed so as to be switchable from each other, once the scan button 712 is pressed, the CPU 211 generates the job information via the display control unit 427 and adds the masking mode set in S601 to the job information. Subsequently, the CPU 211 adds the contents set on all the preset detail screens to the job information via the display control unit 427. Subsequently, the CPU 211 holds the job information in the RAM 213 via the display control unit 427 and ends the processing flow of the flowchart illustrated in FIG. 6A. In a case where the contents of the preset are composite, it is possible to perform masking designation that is a combination of the “character string designation”, the “information type designation”, and the “region designation”.

Additionally, unlike the processing of the flowchart illustrated in FIG. 6A, a configuration in which the character string designation, the information type designation, and the region designation can be all designated may be applied. FIG. 6B is a flowchart in a case where the character string designation, the information type designation, and the region designation can be designated in combination with each other in the main screen display processing in S501 in the present embodiment.

In S601, the CPU 211 generates the main screen via the display control unit 427 and displays the main screen on the touch panel of the operation unit 220 via the UI display unit 414. FIG. 7I illustrates an example of the main screen in the present embodiment. A main screen 780 includes a masking mode list 781. In the present embodiment, the masking mode list 781 includes a manual designation button 782 and the preset designation button 705; however, another button may be included. In a case where the main screen is displayed, the processing proceeds to S602.

In S602, the CPU 211 determines the masking mode selected by the user via the display control unit 427 and the input reception unit 429. In a case where manual designation is selected, the processing proceeds to S603. In a case where preset designation is selected, the processing proceeds to S606.

In S603, S604 and S605, the CPU 211 performs processing similar to that in a case of the flowchart illustrated in FIG. 6A via the display control unit 427. In a case where there is processing that is not used in the character string designation, the information type designation, and the region designation, the processing proceeds to the next processing without executing the concerned processing. The CPU 211 stores the information designated by the user in the composite processing into the job information, holds the job information in the RAM 213, and ends the processing flow of the flowchart illustrated in FIG. 6B. In S606, the CPU 211 performs processing similar to that in a case of the flowchart illustrated in FIG. 6A via the display control unit 427. The CPU 211 generates the job information, holds the job information in the RAM 213, and ends the processing flow of the flowchart illustrated in FIG. 6B. With the execution of the processing flow illustrated in FIG. 6B, it is also possible to perform the masking designation that is a combination of the “character string designation” or the “information type designation” that uses a result of the character recognition processing and the “region designation” that is executed regardless of whether the character recognition processing is executed.

In the processing flow illustrated in FIG. 6A, basically, the image processing unit 423 operates in a mode to perform one type of masking processing. In the processing flow illustrated in FIG. 6B, the image processing unit 423 operates in a mode to perform plural different types of masking processing. That is, as illustrated in FIGS. 6A and 6B, the image processing unit 423 may have the mode to perform one type of masking processing and the mode to perform plural different types of masking processing.

### <Masking Region Specifying Flow>

FIG. 8 is a flowchart explaining the masking region specifying processing in S503 in the present embodiment. Note that, in a case where the masking type included in the job information is blank, the processing in S802, S803, and S804 may be skipped. Additionally, in a case where the masking type included in the job information is only the rectangular region, the processing in S802 and S803 may be skipped. In S801, the CPU 211 obtains the image data from the RAM 213 via the image processing unit 423, performs oblique correction and rotation correction, and stores the corrected image data in the RAM 213. In a case where the corrected image data is stored in the RAM 213, the processing proceeds to S802. In S802, the CPU 211 converts the corrected image data into a 1 channel image to improve the OCR accuracy via the image processing unit 423, performs OCR, and store the extracted character string and the character string region corresponding to the extracted character string in the RAM 213. That is, the CPU 211 extracts the character string by selecting a region (the character string region) in which the character string exists by performing block selection (BS) and executing the OCR processing (the character recognition processing) on the character string region. In a case where the extracted character string and the character string region are stored in the RAM 213, the processing proceeds to S803. An OCR result table illustrating an example of the extracted character string and the character string region in the present embodiment is shown in Table 1. Note that, there is no character string in the region that is determined as an image or the like as a result of the block selection; for this reason, no OCR processing (the character recognition processing) is performed on the concerned region.

TABLE 1

| | character string region (coordinates |
|---|---|
| character string | of starting point, ending point) |
| Iroha Co., Ltd. | (141, 161), (397, 345) |
| Kiyano | (341, 461), (997, 545) |
| 090-0000-2111 | (441, 557), (1369, 653) |
| product code can0n | (677, 324), (768, 6 77) |

In S803, the CPU 211 performs information detection processing based on the character string extracted in S802 via the information detection unit 428, adds the corresponding information type to the character string and the character string region, and stores the information type in the RAM 213 as the information detection result. In this case, the information detection processing is processing in which the CPU 211 determines whether the character string is a character string that corresponds to any one of the predetermined detectable information types and stores the corresponding information type in the information detection result. An example in which the information detection result generated in the present embodiment is added is shown in Table 2. For example, in a case where the character string is “Iroha Co., Ltd.”, the CPU 211 determines that the character string corresponds to the information type “company name” and stores the information type, the character string, and the character string region in the information detection result. In a case where the character string corresponds to none of the information types, the CPU 211 sets the character string as the information type “-(NA)” and stores the information type in the RAM 213. The information detection processing may be determination based on a predetermined rule or may be determination using machine learning. Additionally, the information detection processing may be determination performed by calling an external service via the Internet access unit 426. In a case where the information type is added, the processing proceeds to S804.

TABLE 2

| | | character string region |
|---|---|---|
| information | | (coordinates of starting |
| type | character string | point, ending point) |
| company name | Iroha Co., Ltd. | (141, 161), (397, 345) |
| name | Kiyano | (341, 461), (997, 545) |
| phone number | 090-0000-2111 | (441, 557), (1369, 653) |
| —(NA) | product code can0n | (677, 324), (768, 677) |

In S804, the CPU 211 generates the masking information based on the job information obtained in S501 via the image processing unit 423 and the information detection result obtained in S803 and stores the concerned masking information in the RAM 213. The masking information includes the masking type, the character string, masking necessity, and the masking region. The masking necessity is information indicating whether to mask the concerned item. The masking region is information indicating the coordinates of the starting point and the ending point of the rectangular region in the image in which the masking is performed. A table in which the masking information is added is shown in Table 3.

TABLE 3

| | | | masking region |
|---|---|---|---|
| | | | (coordinates of |
| | character | masking | starting point, |
| masking type | string | necessity | ending point) |
| designated | product code | necessary | (677, 324), |
| character string | can0n | | (768, 677) |
| company name | Iroha Co., | necessary | (141, 161), |
| | Ltd. | | (397, 345) |
| name | Kiyano | unnecessary | (341, 461), |
| | | | (997, 545) |
| phone number | 090-0000-2111 | unnecessary | (441, 557), |
| | | | (1369, 653) |
| rectangular | —(NA) | necessary | (341, 461), |
| region | | | (997, 545) |
| rectangular | —(NA) | necessary | (441, 557), |
| region | | | (1369, 653) |

First, the CPU 211 generates blank masking information via the image processing unit 423. Subsequently, in a case where the masking character string is included in the job information via the image processing unit 423, the CPU 211 determines whether the concerned character string matches the character string of the information detection result. In a case where the two character strings match, the CPU 211 stores the masking type as “designated character string”, the character string as the concerned character string, the masking necessity as “necessary”, and the masking region as the corresponding character string region in the masking information.

Additionally, in a case where the masking type is included in the job information, the CPU 211 determines whether the concerned masking type matches the information type of the information detection result. In a case where the masking type and the information type match, the CPU 211 stores the masking type as the concerned information type, the character string as the concerned character string, the masking necessity as “necessary”, and the masking region as the corresponding character string region in the masking information. In a case where the masking type and the information type do not match, the CPU 211 stores the masking necessity as “unnecessary” in the masking information, similarly. Subsequently, regarding the item in which the masking type included in the job information is the rectangular region, the CPU 211 stores the masking type as “rectangular region”, the character string as “-(NA)”, the masking necessity as “necessary”, and the masking region as the concerned masking region in the masking information. In a case where the processing in S804 is completed, the processing of the flowchart illustrated in FIG. 8 ends.

### <Masking Editing Flow>

FIG. 9 is a flowchart explaining the masking editing processing in S504 in the present embodiment. In S901, the CPU 211 obtains the corrected image data created in S801 via the image processing unit 423 and the masking information created in S804 or S905 from the RAM 213. The CPU 211 obtains the masking region (the starting point coordinate/the ending point coordinate) that needs masking from the obtained masking information via the image processing unit 423. The CPU 211 performs masking on the rectangular region generated in the coordinate positions same as that on the corrected image data and generates the masking image. The CPU 211 stores the generated masking image in the RAM 213 via the image processing unit 423. In a case where the masking image is stored in the RAM 213, the processing proceeds to S902.

In S902, the CPU 211 obtains the masking image generated in S901 from the RAM 213 via the display control unit 427 to generate a preview screen 1000 in FIG. 10A or 10B and displays the preview screen 1000 on the touch panel via the UI display unit 414. In a case where the preview screen 1000 is displayed, the processing proceeds to S903.

FIGS. 10A and 10B illustrate an example of the preview screen 1000 to display a preview of the masking image regarding the present embodiment. The preview screen 1000 has the following configuration. A masking image preview display region 1001 displays the masking image created in S901. In a case where the masking image is not fully fitted within the screen, the masking image preview display region 1001 automatically displays a scroll bar. A preview display region enlargement button 1002 is a button to enlarge and display the masking image preview display region 1001 while increasing the display magnification by a certain amount. A preview display region fitting button 1003 is a button to change the magnification to the maximum that allows the masking image to be fitted within the masking image preview display region 1001. A preview region contraction button 1004 is a button to contract and display the masking image preview display region 1001 while decreasing the display magnification by a certain amount.

A preceding page button 1007 is a button to display the scanned image on the previous page in a case where there are plural pages of scanned images. A page number display 1008 displays the page of the scanned image currently displayed and the total page number. A next page button 1009 is a button to display the scanned image on the next page in a case where there are plural pages of scanned images. A masking delete button 1011 is a button to cancel the masking designated in the masking image preview display region 1001. Specifically, in a case where a masking selection button 1013 is selected via the display control unit 427 and the input reception unit 429, the CPU 211 executes the following operations. In a case where the CPU 211 detects that the masking having the masking necessity “necessary” is pressed on the image data of the masking image, the CPU 211 recognizes that the concerned masking is designated for the next operation. Then, in a case where the CPU 211 detects that the masking delete button 1011 is pressed subsequent to the concerned designation via the display control unit 427 and the input reception unit 429, the CPU 211 sets the masking necessity of the masking information to “unnecessary”. The CPU 211 creates the masking image based on the updated masking information via the image processing unit 423 and updates the masking image preview display region 1001.

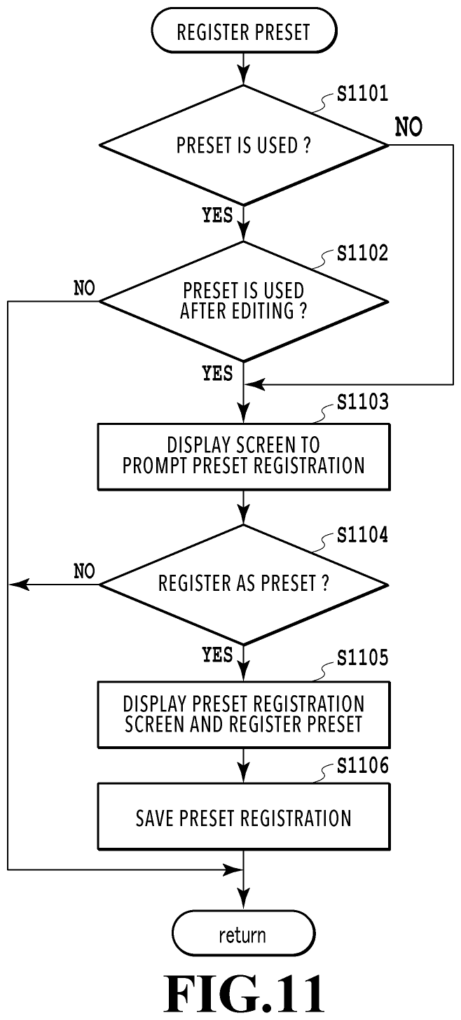

In a case where a masking instruction button 1012 is selected via the display control unit 427 and the input reception unit 429, the CPU 211 performs the following operations. The CPU 211 detects a portion of the image of the masking region displayed on the touch panel that is touched with a finger, a stylus pen, or the like as the starting point via the display control unit 427 and the input reception unit 429. Subsequently, in a case where the CPU 211 detects the ending point at which the finger, the stylus pen, or the like is removed after dragging via the display control unit 427 and the input reception unit 429, the CPU 211 recognizes the rectangular region designated by the starting point and the ending point as a masking 1006. The masking 1006 in FIG. 11A is a display during the dragging with the finger, the stylus pen, or the like, and the masking 1006 in FIG. 11B is an example illustrating the masking 1006 of a case where the rectangular region is set with the finger, the stylus pen, or the like being removed from the touch panel after dragging. A masking 1005 is a region already masked by the masking region. A print button 1014 is a button to designate the masking printing with the masking image currently displayed as a preview.

A character string designation input form 1021 is a form to input the character string to be the masking target. The character string designation input form 1021 has a similar function as that of the above-described character string input form 711. An information type designation input form 1022 is a form to input the information type to be the masking target. The information type designation input form 1022 has a similar function as that of the information type list 721. Note that, in a case where the region is designated by the processing of the flowchart in FIG. 6A, the configuration of the preview screen is not limited to the configuration in FIG. 10. Based on the region designation method selected in S602, a preview screen including at least one of the function of receiving the designation of the region by dragging on the masking image preview display region 1001, the character string designation input form, and the information type designation input form may be displayed. For example, in a case where the character string designation is selected in S602, the character string designation input form is displayed so as to be able to revise the character string designation on the preview screen. Additionally, in a case where the information type designation is selected in S602, the information type designation input form is displayed so as to be able to revise the selection of the information type on the preview screen. Additionally, in a case where the region designation is selected in S602, the preview screen is displayed so as to be able to designate the region on the preview screen.

In S903, the CPU 211 determines whether the print button 1014 is pressed via the display control unit 427 and the input reception unit 429. In a case where the CPU 211 determines that the print button 1014 is pressed via the display control unit 427 and the input reception unit 429 (YES in S903), the processing flow of the flowchart illustrated in FIG. 9 ends. In a case where the CPU 211 determines that the print button 1014 is not pressed via the display control unit 427 and the input reception unit 429 (NO in S903), the processing proceeds to S904.

In S904, the CPU 211 determines whether the designation of the masking 1006, the input to the character string designation input form 1021, or the input to the information type designation input form 1022 are detected via the display control unit 427, the input reception unit 429, and the UI display unit 414. If the CPU 211 determines that the masking designation and the like are performed in S904 via the display control unit 427 and the input reception unit 429 (YES in S904), the processing proceeds to S905. In a case where the CPU 211 determines that the masking designation and the like are not performed in S904 via the display control unit 427 and the input reception unit 429, the processing returns to S902.

In S905, the CPU 211 obtains the masking 1006 designated on the touch panel via the display control unit 427, the input reception unit 429, and the UI display unit 414 and converts the masking 1006 into the rectangular region on the masking image displayed as the preview image. The CPU 211 obtains the masking information created in S804 or S905 via the display control unit 427. The CPU 211 adds the masking type as “rectangular region”, the character string as “-(NA)”, the masking necessity as “necessary”, and the masking region (coordinates of starting point, ending point) as the converted rectangular region to the concerned masking information and stores the masking information in the RAM 213. Table 4 illustrates an example in which the rectangular region is added to the Table 3.

TABLE 4

| | | | masking region |
|---|---|---|---|
| | | | (coordinates of |
| | character | masking | starting point, |
| masking type | string | necessity | ending point) |
| designated | product code | necessary | (677, 324), |
| character string | can0n | | (768, 677) |
| company name | Iroha Co., | necessary | (141, 161), |
| | Ltd. | | (397, 345) |
| name | Kiyano | unnecessary | (341, 461), |
| | | | (997, 545) |
| phone number | 090-0000-2111 | unnecessary | (441, 557), |
| | | | (1369, 653) |
| rectangular | —(NA) | necessary | (341, 461), |
| region | | | (997, 545) |
| rectangular | —(NA) | necessary | (441, 557), |
| region | | | (1369, 653) |
| rectangular | —(NA) | necessary | (441, 957), |
| region | | | (1369, 1057) |

The CPU 211 determines whether the character string inputted to the character string designation input form 1021 via the display control unit 427 and the input reception unit 429 corresponds to the character string in the masking information. In a case where the inputted character string corresponds to the character string in the masking information, the CPU 211 changes the masking necessity of the corresponding item to “necessary”. The CPU 211 changes the item of the masking type of the masking information corresponding to the item of the information type that has the toggle button changed in the information type designation input form 1022 via the display control unit 427 and the input reception unit 429. In a case where the toggle button is changed to ON, the CPU 211 changes the masking necessity to “necessary”. In a case where the toggle button is changed to OFF, the CPU 211 changes the masking necessity to “unnecessary”. In a case where the CPU 211 completes the above-described processing in S905, the processing returns to S901.

### <Preset Registration Flow>

FIG. 11 is a flowchart explaining the preset registration processing in S506 in the present embodiment. In S1101, the CPU 211 determines whether the masking mode included in the job information is the preset designation via the display control unit 427. In a case where the masking mode is the preset designation, the processing proceeds to S1102. In a case where the masking mode is not the preset designation, the processing proceeds to S1103.

In S1102, the CPU 211 determines whether the preset designated in S606 is edited in response to the input by the user via the display control unit 427 and the input reception unit 429. In a case where the preset is edited, the processing proceeds to S1103. In a case where the preset is not edited, the processing flow of the flowchart illustrated in FIG. 11 ends. In S1103, the CPU 211 displays on the operation unit 220 a screen (not illustrated) to confirm the user whether to perform the preset registration via the display control unit 427 and the UI display unit 414.

In S1104, the CPU 211 determines whether the preset registration is selected in response to the operation by the user via the display control unit 427 and the input reception unit 429. In a case where the registration is selected, the processing proceeds to S1105. In a case where the registration is not selected, the processing flow of the flowchart illustrated in FIG. 11 ends. In S1105, the CPU 211 displays the preset registration screen on the operation unit 220 via the display control unit 427 and the UI display unit 414. The preset registration screen is a screen that allows for the registration of the masking information performed in the present embodiment as a preset. In a case where the CPU 211 executes the processing in S1105, the processing proceeds to S1106.

In S1105, the CPU 211 generates the preset registration screen according to the masking type of the masking information. The preset registration screen for the character string designation is generated for the item in which the masking type is the designated character string. The preset registration screen for the information type designation is generated for the item in which the masking type is the predetermined detectable information type. The preset registration screen for the region designation is generated for the item in which the masking type is the rectangular region. In a case where plural masking types of the masking information, which are the designated character string, the predetermined detectable information type, and the rectangular region, are included, the CPU 211 displays the corresponding preset registration screens so as to be switchable from each other.

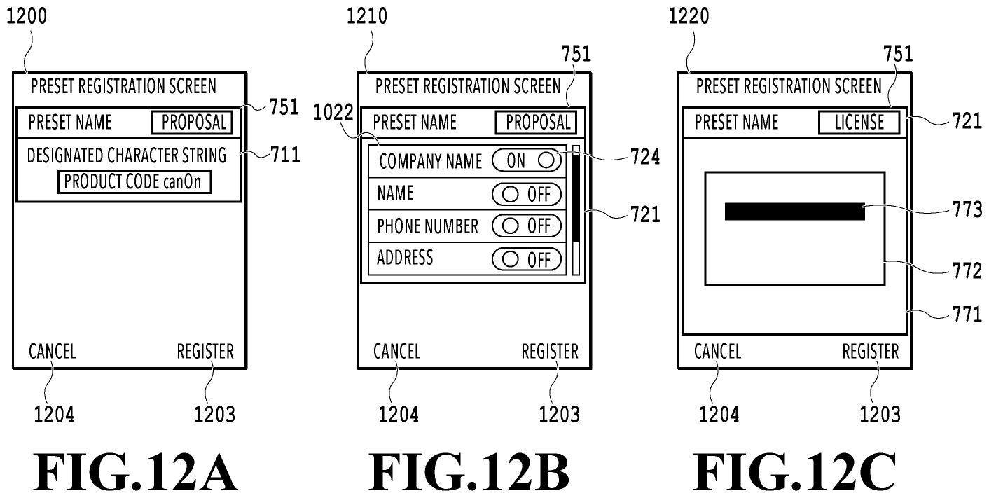

FIG. 12A illustrates an example of the preset registration screen for the character string designation in the present embodiment. A preset registration screen 1200 includes the preset name 751, the character string input form 711, a registration button 1203, and a cancel button 1204. The preset name 751 and the character string input form 711 have similar functions as that of the items on the preset detail screen 750. In the preset name 751, the character string can be edited freely in response to the input by the user. In the character string input form 711, the character string is determined according to the masking information. For example, in a case where the masking information includes the items in which the masking necessity is “necessary”, the information type is “designated character string”, and the character string is “product code can0n”, “product code can0n” is displayed in the character string input form 711. Additionally, the CPU 211 may edit the masking character string in the character string input form 711 in response to the input from the user via the display control unit 427 and the input reception unit 429.

The registration button 1203 is a button to register and set the information displayed on the preset registration screen as a preset. In a case where the registration button 1203 is pressed on the preset registration screen 1200, the CPU 211 registers the information displayed in the preset name 751 and the character string input form 711 as a preset via the display control unit 427. For example, in a case where “proposal 2” is inputted in the preset name 751, the preset in which the preset name is “proposal 2” is created and registered. In addition, in a case where “product code can0n” is inputted in the character string input form 711 on the preset registration screen 1200, the masking character string “product code can0n” is stored and registered into the preset having the preset name “proposal 2”. The cancel button 1204 is a button to end the present embodiment without performing the preset registration processing.

FIG. 12B illustrates an example of the preset registration screen for the information type designation in the present embodiment. A preset registration screen 1210 includes the preset name 751, the information type list 721, the registration button 1203, and the cancel button 1204. The preset name 751 and the information type list 721 have similar functions as that of the items on the preset detail screen 760. The CPU 211 can edit the character string in the preset name 751 in response to the input by the user via the display control unit 427 and the input reception unit 429. In the information type list 721, ON or OFF of the toggle button 724 is determined according to the masking information. For example, in a case where the masking information includes the item in which the masking necessity is “necessary” and the information type is “company name”, the toggle button 724 of the item of the company name in the information type list 721 is determined as ON. Additionally, the CPU 211 may edit the toggle button 724 in the information type list 721 in response to the input by the user via the display control unit 427 and the input reception unit 429.

In a case where the registration button 1203 is pressed on the preset registration screen 1210, the CPU 211 registers the information displayed in the preset name 751 as the preset via the display control unit 427. In addition, the CPU 211 stores and registers the information type of the item having the toggle button 724 that is ON in the information type list 721 into the preset via the display control unit 427. For example, in a case where “contract 2” is inputted in the preset name 751, the preset in which the preset name is “contract 2” is created and registered. In addition, it is assumed that the toggle button 724 of the item “company name” is ON in the information type list 721 on the preset registration screen 1210. The masking type in which the type is “company name” is stored and registered into the preset having the preset name “contract 2”.

FIG. 12C illustrates an example of the preset registration screen for the region designation in the present embodiment. A preset registration screen 1220 includes the preset name 751, the preset preview 771, the registration button 1203, and the cancel button 1204. The preset name 751 and the preset preview 771 have similar functions as that of the items on the preset detail screen 770. In the preset preview 771, the CPU 211 obtains the corrected image data from the RAM 213 via the display control unit 427, obtains the image size from the corrected image data, and displays the outline of the image on the image outline preview 772. Additionally, based on the masking region of the masking information, the CPU 211 displays the rectangular region as the masking 773 in the same positions of the coordinates on the image outline preview 772 via the display control unit 427 and the UI display unit 414. In a case where the registration button 1203 is pressed on the preset registration screen 1220, the CPU 211 registers the preset name 751, the image size of the corrected image data, and the masking region as the preset via the display control unit 427.

In any preset registration screens, in a case where the registration button 1203 is pressed, the preset having the contents on the individual preset registration screen may be registered, or the contents on all the preset registration screens may be combined as one preset and registered.

In S1106, the CPU 211 saves the preset set in S1105 via the display control unit 427 and the data management unit 424. The CPU 211 may save the preset to the external storage 120 via the data management unit 424 and the Internet access unit 426 or may save the preset to the HDD 214 via the data management unit 424 and the internal data saving unit 412. In this process, in a case where the preset that has the same name is already saved in the HDD 214 or the external storage 120 via the display control unit 427, the CPU 211 may display on the operation unit 220 an alert display to inquire the user whether to overwrite and save. Additionally, in a case where the preset registration is normally completed, the CPU 211 may display on the operation unit 220 a display indicating the completion of the preset registration via the display control unit 427.

As above, with the character string designation, the information type designation, the region designate, or the preset designation being provided to the user as the masking processing, it is possible to allow the user to use the masking processing that matches a use case. Additionally, the user can perform desired masking such as masking with designation of any region, collective masking of any character strings, or masking with a combination of two or more processing methods. Thus, the user can use the masking processing that matches a use case.

### Second Embodiment

In the present embodiment, the improvement of the convenience during the preset designation by storing the number of times of using the preset is described specifically. Note that, in the descriptions of the present embodiment, descriptions of a portion having the same configuration and processing procedure as that of the first embodiment are omitted, and only a different portion is described.

In a case where the CPU 211 saves or obtains the preset via the data management unit 424, the CPU 211 adds and saves the number of times that the preset is used to the corresponding preset as the number of preset usage. Additionally, the CPU 211 may add and save the date and time in which the preset is used last time to the corresponding preset as the preset last usage date and time via the data management unit 424. In S606, in a case where the CPU 211 generates the preset designation screen based on the obtained preset list via the display control unit 427, the CPU 211 generates the preset list 741 such that the number of preset usage is in descending order. Additionally, the CPU 211 may generate the preset list 741 such that the preset last usage date and time is in descending order via the display control unit 427.

As above, the sorting of the preset list by using the number of preset usage or the preset last usage date and time allows the user to easily find the preset used often or the preset used last time, and the usability is improved. As described above, the user can perform masking with designation of any region, collective masking of any character strings, or masking with a combination of two or more masking processing methods. Thus, it is possible to perform the masking processing that matches a use case.

### Third Embodiment

In the present embodiment, the proper masking during the region designation that is achieved by correcting a misalignment of the original document in a case of executing scanning by the MFP is described specifically. In the descriptions of the present embodiment, descriptions of a portion having the same configuration and processing procedure as that of the first embodiment are omitted, and only a different portion is described.

In S801 in the flowchart illustrated in FIG. 8, the CPU 211 obtains the image data from the RAM 213 via the image processing unit 423, performs the position correction, and stores the corrected image data in the RAM 213. The position correction is processing to correct the image that is scanned while being misaligned greatly from the origin of the document table or the image that is scanned while being put at an angle to the document table so as to make the same origins as the base point.

First, the CPU 211 detects that the original document is scanned while being put not based on the origin of the document table as the base point on the image data via the image processing unit 423. For example, it is a case where the CPU 211 detects that an upper left vertex of the rectangular region of the original document is away from the origin of the image by a predetermined value in the image, or it is a case where the CPU 211 detects that four sides of the rectangular region of the original document are not orthogonal to the coordination system of the image. The misalignment of the original document may be detected by another method.

In a case where the misalignment of the original document is detected, the CPU 211 performs oblique correction and rotation correction such that the four sides of the rectangular region of the original document included in the image data erect via the image processing unit 423, and thereafter, the image is moved parallel such that the origin of the original document is the origin of the image data, and the corrected image data is generated. Alternatively, the CPU 211 may cut out the portion of the original document via the image processing unit 423 and perform rotation correction and parallel movement on the cutout image data to generate the corrected image data. Subsequently, the CPU 211 stores the corrected image data in the RAM 213 via the image processing unit 423.

As above, with the position correction being performed, it is possible to execute the masking by directly using the coordinates of the rectangular region in the region designation regardless of how the original document is put on the document table, and the usability is improved. As described above, the user can perform masking with designation of any region, collective masking of any character strings, or masking with a combination of two or more masking processing methods. Thus, it is possible to perform the masking processing that matches a use case.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-122391, filed Jul. 27, 2023, which is hereby incorporated by reference wherein in its entirety.

What is claimed is:

1. A non-transitory computer readable storage medium storing an application which causes a computer to execute a method of controlling an image processing apparatus, the method comprising:
displaying, on a display unit, a screen to designate a region where masking processing is performed using a method selected from a plurality of different methods, in which the region where the masking processing is performed in image data obtained by scanning a document by a scanner included in the image processing apparatus is designated; and
performing the masking processing on the image data based on designation on the screen, wherein
the plurality of different methods include a first method in which the region where the masking processing is performed is designated by selecting a type of a character string included in the region where the masking processing is performed, and a second method in which the region where which the masking processing is performed is designated by designating a position of the region where the masking processing is performed.

2. The non-transitory computer readable storage medium according to claim 1, wherein
the plurality of the different methods further include a third method in which the region where the masking processing is performed is designated by designating a character string included in the region where the masking processing is performed.

3. The non-transitory computer readable storage medium according to claim 1, wherein the method further comprising:
saving information of the region designated on the screen to a memory of the image processing apparatus as preset designation; and
performing the masking processing on other image data obtained by scanning another document by the scanner by using the saved preset designation.

4. The non-transitory computer readable storage medium according to claim 2, wherein the method further comprising:
in a case where the selected method to designate the region where the masking processing is performed is the third method,
receiving a user input to designate the character string on a screen to perform designation by the third method; and
performing the masking processing on a character string region including the character string.

5. The non-transitory computer readable storage medium according to claim 1, wherein the method further comprising:
in a case where the selected method to designate the region where the masking processing is performed is the first method,
receiving a user input to select a type of the character string on a screen to perform designation by the first method; and
performing the masking processing on a character string region including a character string corresponding to the designated type of the character string.

6. The non-transitory computer readable storage medium according to claim 1, wherein
the type of the character string includes a company name, a name, a phone number, an address, a FAX number, an e-mail address, a uniform resource locator (URL), a credit card number, and a one dimensional or two dimensional code image.

7. The non-transitory computer readable storage medium according to claim 1, wherein the method further comprising:
in a case where the selected method to designate the region where the masking processing is performed is the second method,
receiving a user input to designate a position of the region to be masked on a screen to perform designation by the second method; and
performing the masking processing on a region in the designated position.

8. The non-transitory computer readable storage medium according to claim 3, wherein
the plurality of the different methods further include a fourth method in which the region where the masking processing is performed is designated by using the preset designation saved in the memory,
the method further comprising:
in a case where the selected method to designate the region where the masking processing is performed is the fourth method,
receiving preset designation selected from a plurality of types of preset designation displayed on a screen to perform designation by the fourth method; and
performing the masking processing based on the selected preset designation.

9. The non-transitory computer readable storage medium according to claim 8, wherein the method further comprising:
displaying, on the display unit, the plurality of the types of the preset designation based on the number of usage by a user on the screen to perform designation by the fourth method.

10. The non-transitory computer readable storage medium according to claim 8, wherein the method further comprising:
displaying, on the display unit, the plurality of the types of the preset designation based on the last usage date and time on the screen to perform designation by the fourth method.

11. The non-transitory computer readable storage medium according to claim 1, wherein the method further comprising:
displaying a preview screen on the display unit before the masking processing is performed.

12. The non-transitory computer readable storage medium according to claim 2, wherein the method further comprising:
displaying a preview screen on the display unit before the masking processing is executed.

13. The non-transitory computer readable storage medium according to claim 12, wherein
the preview screen includes a screen to input the character string designated in the third method, a screen to select the type of the character string selected in the first method, and a screen to designate the position of the region where the masking processing is performed in the second method.

14. The non-transitory computer readable storage medium according to claim 1, wherein
the masking processing is processing to mask a designated region in the image data with black color.

15. The non-transitory computer readable storage medium according to claim 1, wherein
the masking processing is processing to mask a designated region in the image data with a background color of the image data.

16. The non-transitory computer readable storage medium according to claim 2, wherein the method further comprising:
in a case where it is detected that the already-obtained image data and other image data newly obtained by scanning another document by the scanner are misaligned, obliquely rotating the newly-obtained other image data such that four sides of the newly-obtained other image data erect; and
correcting the obliquely rotated other image data such that an origin of the obliquely rotated other image data matches an origin of the already-obtained image data.

17. A method of controlling an image processing apparatus, the method comprising:
displaying, on a display unit, a screen to designate a region where masking processing is performed using a method selected from a plurality of different methods, in which the region where the masking processing is performed in image data obtained by scanning a document by a scanner included in the image processing apparatus is designated; and
performing the masking processing on the image data based on designation on the screen, wherein
the plurality of different methods include a first method in which the region where the masking processing is performed is designated by selecting a type of a character string included in the region where the masking processing is performed, and a second method in which the region where which the masking processing is performed is designated by designating a position of the region where the masking processing is performed.

18. An image processing apparatus comprising:
at least one memory that stores instructions; and
at least one processor that executes the instructions to:
displaying, on a display unit, a screen to designate a region where masking processing is performed using a method selected from a plurality of different methods, in which the region where the masking processing is performed in image data obtained by scanning a document by a scanner included in the image processing apparatus is designated; and
performing the masking processing on the image data based on designation on the screen, wherein
the plurality of different methods include a first method in which the region where the masking processing is performed is designated by selecting a type of a character string included in the region where the masking processing is performed, and a second method in which the region where which the masking processing is performed is designated by designating a position of the region where the masking processing is performed.

19. A non-transitory computer readable storage medium storing an application which causes a computer to execute a method of controlling an image processing apparatus, the method comprising:
receiving selection of a type of a character string included in a region where masking processing is performed in image data;
obtaining the image data by scanning a document by a scanner included in the image processing apparatus;
further receiving designation of a position of the region where the masking processing is performed on the obtained image data; and
performing the masking processing on a region including the selected type of the character string and a region in the designated position in the obtained image data.
